(19) United States
(12) Patent Application Publication
(10) Pub. No.: US 2010/0188292 A1
(43) Pub. Date: Jul. 29, 2010

(54) Antenna

(76) Inventor: Tomas Rutfors, Holmsund (SE)

Correspondence Address: Mark P Stone, 50 Broadway, Hawthorne, NY, 10532, US

(21) Appl. No.: 12/310,633

(22) PCT Filed: Sep. 3, 2007
(86) PCT No.: PCT/SE2007/000767

§ 371 Date: Feb. 27, 2009

(30) Foreign Application Priority Data
Sep. 4, 2006 (SE) 0601815-4

(51) Int. Cl. H01Q 1/38; H01Q 1/36

(52) U.S. Cl. 343/700 MS

(57) ABSTRACT

Antenna that offer simple mounting and possibility for modification, where the antenna element of electrical conductive material have a spacer of electrical insulator applied by adhesive and where the spacer also have adhesive intended for mounting on substrate of for example printed circuit board. The antenna offer big possibility to design antennas for different communication bands and different sizes without need for customisation of either carrier or printed circuit board.

### TECHNICAL FIELD

The present invention concerns an antenna that easily can be modified and mounted.

### STATE OF THE ART AND BACKGROUND OF THE INVENTION

The purpose of an antenna is to convert wire bound signals to electromagnetic signals propagating in the ambient media. The design of the antenna determines the properties of this conversion. Important parameters are antenna gain, efficiency, directivity, polarisation, bandwidth and not least physical size. The requirements of a wireless communications system determine the requirements of the antenna and by that what type of antenna to be used.

Simple and small antennas have become attractive both because its decreased production cost and that they easily can be deployed in both fixed and mobile installations. Antennas adopted for embedding offer a low cost solution. A common group of embedded antennas is planar antennas often denominated as patch antennas. A very important parameter for patch antennas to obtain enough bandwidth is to create sufficient spacing to a ground plane in parallel.

There are some known methods to embody planar antennas. By the denomination planar antenna means that the main part of the antenna area mainly is in parallel to and separated from a ground plane. In general the antenna element is connected to a radio transmitter and/or receiver by electrical conductors. A present common method is etching or printing an antenna shape of a foil of copper on a thin and flexible substrate of polyamide or polyester. It is denominated Flex film, which is applied by any type of adhesive on a plastic carrier that is adapted to the product and is produced by injection moulding process, and that the electrical signals are connected between the radio transmitter and antenna element by spring loaded pins. The carrier includes joints to fix the antenna on a printed circuit board and the printed circuit board has to be adapted to the carrier joints. This is a solution that primarily is suited for mass production, because the injection moulding tool is costly and that flexible films have to be produced in big quantities to achieve a low price. The flex film can be replaced by a stamped metal plate that is applied by adhesive or ultra sonic welding, but also in this case the carrier have to be adapted to each product that also implies mass production. By the denomination mass production means a quantity exceeding 100 000 units. A method that is more common for small quantity is etching of the antenna pattern in a printed circuit board of glass fibre reinforced epoxy laminate or other material intended to printed circuit board process.

This method is flexible but has the limitation that cheaper material of FR4 type get an antenna with significant losses, and when the material has good electrical properties the material cost is high. A sufficient spacing between the antenna and the ground plane is also required for planar antennas to attain sufficient efficiency and bandwidth. This gives that the amount of material and therefore the cost is high.

The method described in U.S. Pat. No. 7,053,833 using polymers instead of glass fibre reinforced epoxy. It is fixed by adhesive to a antenna element and also to the ground plane on opposite side by another adhesive. Thereafter an electrical conductor is elapsed through the polymer and joint by soldering to the antenna element. This method has some drawbacks. Several components and mounting process steps are needed.

The method described in U.S. Pat. No. 6,675,461 assign a production method for an antenna of sheet metal that are folded in such manner that a significant area is overlapping and that a spacer block is fixed between two overlapping sections. This method has more folding and use more amount of material that lead to increased cost and a more complicated production and connection to a printed circuit board than the forthcoming invention.

### DESCRIPTION OF THE INVENTION

This invention has following properties that give significant improved flexibility and also low cost.

The invention includes an antenna element with sufficient stiffness giving possibility to mount a non unique carrier of electrical insulators of different size and shapes to the antenna element. Thereby the carrier can consist of general shaped spacing blocks of non electric conductive material that is mounted by adhesive of any kind, giving possibility to adapt placing of them on the antenna element. The antenna is also mounded by adhesive when attaching onto, of example, a printed circuit board that not requires special adaptation for the fixing of the antenna.

The invention can include folding or bending of at least one part of the antenna element to create a simple and adapted transmission of the radio signal to the antenna element.

By the stiff antenna element the spacer block or insulator doesn't need to cover the whole area of the antenna element. The spacer also don't need to be covered of the antenna element, it can extend from an edge or through holes or slots in the antenna element.

It's an advantage if the spacer block has a low dielectric constant because it gives possibility to attach them on different positions without affecting the resonance frequency of the antenna. It's often good to use porous materials having a relative dielectric constant below 2.

To obtain an antenna having low losses and sufficient bandwidth to cover the whole communications bands and also having a robust design that can be used on several products, it is often needed to place the antenna element on sufficient distance from the substrate, for example the ground plane of a printed circuit board.

Modules including radio transmitter and/or receivers often have a connector for antenna connection. By mounting a coaxial cable having a proper coaxial connector that fits the radio module, and where the other end connects to the terminals of antenna element, a suitable antenna solution also is available for such applications.

An antenna according to this invention advantageous is attached on a printed circuit board including circuits for radio transmitting or receiving but it can also be attached on a printed circuit board not including such circuits.

### DESCRIPTION OF DRAWINGS

FIG. 1: Illustrates a side view of a complete antenna.

FIG. 2: Antenna from another view including spacer block that not cover the whole antenna element.

FIG. 3: Antenna having spring loaded connection pins shaped to connect without soldering.

FIG. 4: Antenna with the connection pins bended to be mounted on connection pads, for example on top of a circuit board.

FIG. 5: Antenna according to FIG. 1 but mounted on a printed circuit board.

FIG. 6: Antenna according to FIG. 2 mounted on a printed circuit board by soldering in holes through the board.

FIG. 7: Antenna according to FIG. 4 mounted on a printed circuit board by soldering on pads on top of the printed circuit board.

FIG. 8: Antenna according to FIG. 3 mounted on a printed circuit board by connection of the signal through spring loaded connectors.

FIG. 9: Antenna with connection through a coaxial cable.

FIG. 10: illustrates different placements on a printed circuit board.

FIG. 11: Illustrates different shapes and placing of spacer blocks on an antenna element.

FIG. 12: Illustrates by an example how an antenna according to the invention can be assembled.

### PREFERRED EMBODIMENTS

This invention consists of an antenna element embodied of an electrical conductive material with sufficient stiffness, for example sheet metal, and a carrier or spacer of a electrical insulator. The sheet metal is shaped to get the properties needed for the application and is manufactured by appropriate methods. Some methods is stamping, etching or cutting. One or more electrical spacer is manufactured to appropriate shape and size and an adhesive is applied onto them. Some manufacturing methods for spacer is stamping, cutting or moulding. As adhesive a material with suited properties is selected and applied with any method. The antenna element and spacer are attached together by the adhesive. On at least one of the spacers, usually all, a adhesive is applied for later assembly on the product that shall contain the antenna. The adhesive can have a protection foil to not be damaged in the handling between the antenna assembly and final mounting on the product. To get a antenna element with sufficient stiffness a electrical conductive material with thickness exceeding 50 micro meter in general is needed. Thin sheet metal of copper, silver, tin, zinc or other electrical conductive material or alloys of different material is often proper.

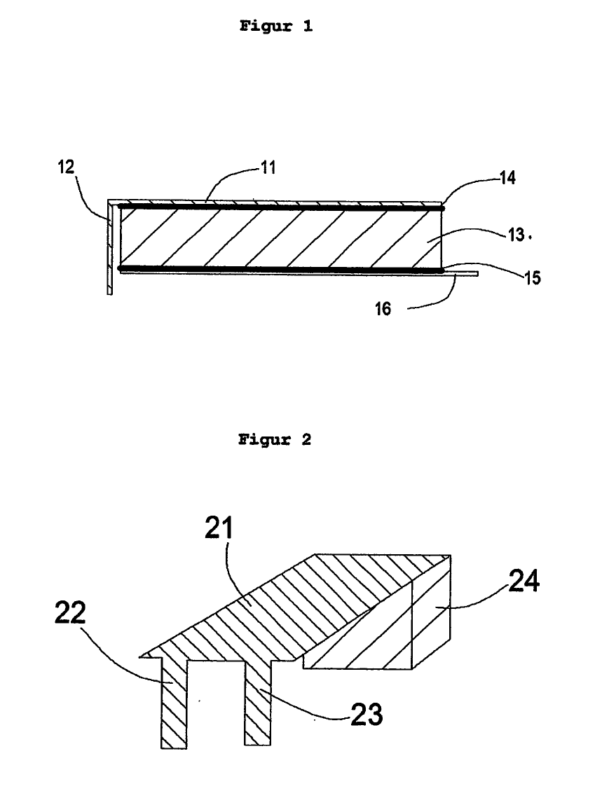

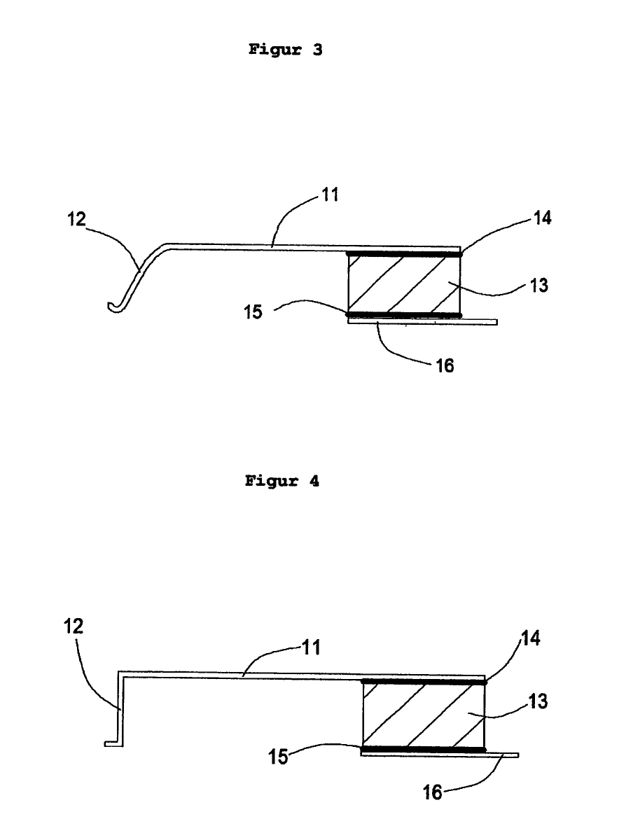

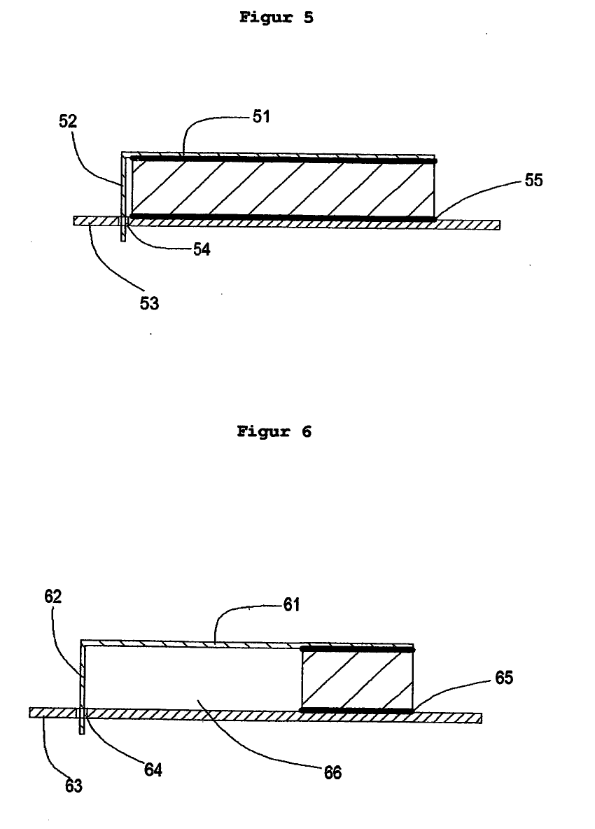

It is also possible to shape connection pins, also denominated terminals, as a part of the antenna element and this part can also be folded for a simple transmission of the radio signal from of example a printed circuit board. This method offers a cheap and adaptable connection of the signal to the antenna element. By reference to FIG. 1 the antenna element (11) is shown including a folded part (12) that not is located in the same plane as the other antenna element and where spacer block (13) and antenna element (11) is mounted by adhesive (14) and where adhesive (15) and protection foil (16) is applied on the spacer block. FIG. 2 illustrates a different view where the antenna element (21) has two terminals (22, 23) which are folded to create a simple connection of the radio signal. The spacer block (24) is smaller than the antenna element giving less material usage increased adaptively for different sizes of antennas and decrease the area used when mounted on the substrate such as printed circuit board. FIGS. 3 and 4 illustrates some other embodiments of connecting terminals.

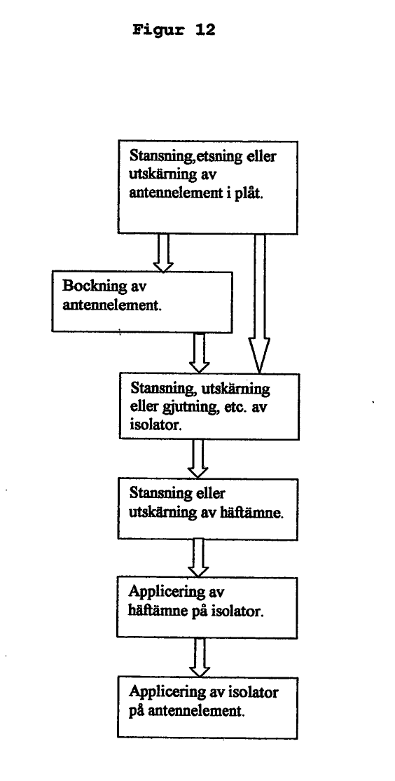

The insulator is by advantage embodied smaller than the antenna element and therefore use less space on, for example, a printed circuit board so the free space can be used, for example, for electrical components. FIG. 2 illustrates a antenna element (11) and spacer block (13) that not cover the whole antenna element and that is shaped according to FIG. 1. Of coarse several spacer can be applied to attain stability to the substrate they shall be mounted at. They can also have different size on the same antenna element. By that the antenna element can be big enough to give good efficiency and bandwidth but still not use to big part of the printed circuit board area and result in an excellent overall concept. FIG. 11 shows a view where the spacer blocks position at the antenna element is shown for three different embodiments of the element. FIG. 11a shows a smaller antenna element (111) with spacer (112), FIG. 11b shows a bigger antenna element (113) where three spacers (114, 115, 116) is placed to obtain stability and FIG. 11c shows a antenna element (117) with a slot where a spacer (118) is placed to cross the slot to obtain stability and where another spacer with different size and shape (119) is placed at another position to further increase the stability. The positioning of the spacer is not critical, they can be placed where it is proper from different aspects. If the antenna element need a bigger separation distance to the surface than the spacer can achieve, several spacer can be attached onto each other by adhesive.

It is advantageous that spacer block is made of porous material containing a significant part of air to not affect the antenna properties depending on its position. By porous material means material with dielectric constant below 2. It can also be blocks including holes that also decrease the overall dielectric constant for the block.

Since it often a demand that the electrical length and therefore the inductance between the signal and ground is less than possible achievable if the pins connects to each other at the antenna element plane, the impedance match can be simplified by that the antenna element and connection pin is shaped in the same sheet of metal and the pins can be connected to each other at a plane closer to the ground plane to get a good impedance match. By that it is possible to place the antenna element at sufficient distance from the ground plane to obtain sufficient bandwidth and by that a more robust design that fits more products without changing the antenna element shape. Also communications standards having wide bandwidth demands also require antennas having corresponding bandwidth giving need for a antenna element placed a significant distance from its mounting surface.

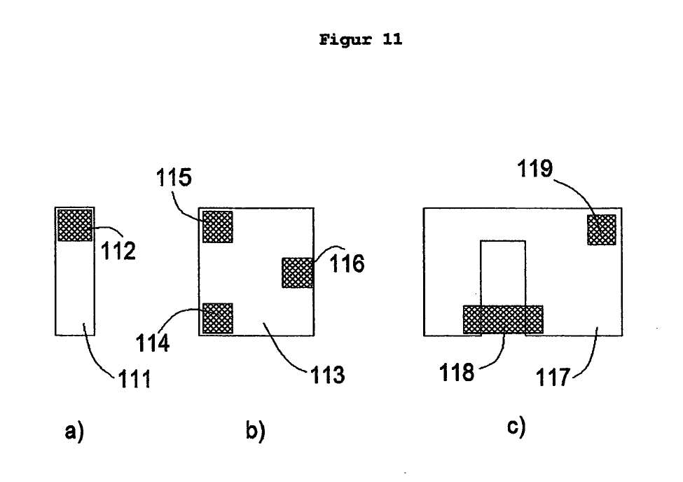

If it is a cable interface to radio transmitter and/or receiver, usually of coaxial type, the antenna terminals is soldered or crimped to the cables two conductors to ensure a good electrical contact. FIG. 9 illustrates the antenna element (91), two terminals or connection pins (92, 93) having electrical connection to the ground (96) and central conductor (97) of the coaxial cable (95). The spacer (94) is attached by adhesive to the antenna element as shown before.

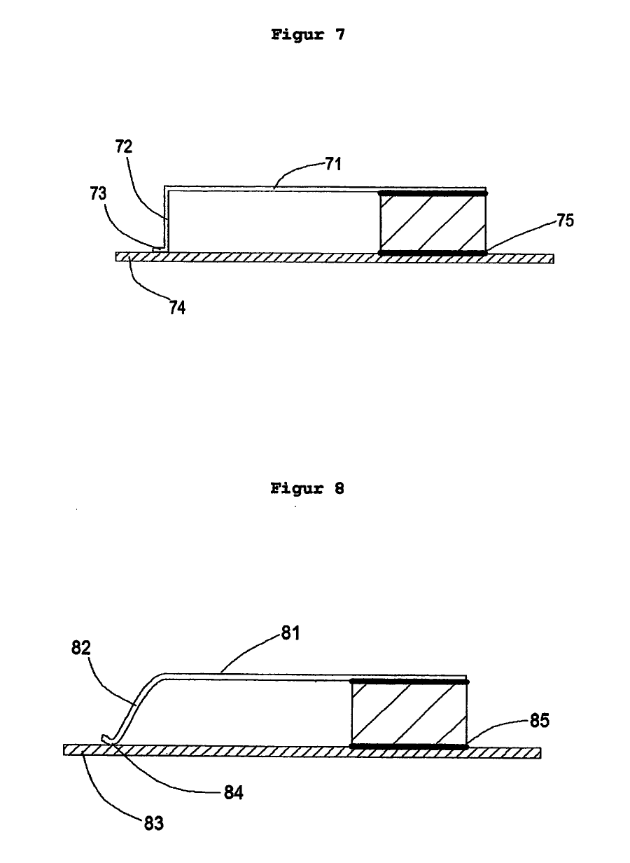

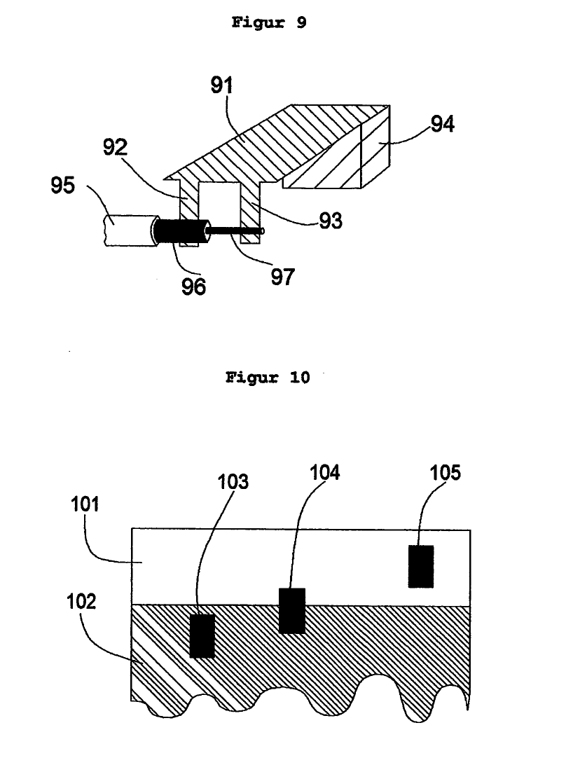

The antenna is mounted by removing the cover or protection foil from the insulator and the antenna is pressed there it is intended to be placed on the mounting substrate. In FIGS. 5, 6, 7 and 8 the antenna cover foil is removed and the adhesive (55, 65, 75, and 85) is attaching the antenna towards the substrate (53, 63, 74, 83). Often the substrate is a printed circuit board including spots intended for connection to the antenna elements terminals. The electrical connection can either be performed by soldering, spring loaded connection or mounting of the coaxial cables terminals either by connector or soldering. The soldering can either be performed in the hole where the antenna terminal is placed into, the FIGS. 5 and 6 shows how the connection terminals (52, 62) is placed in the hole (54, 64) of the printed circuit board (53, 63) where the holes have electrical connection to the radio transmitter and/or receiver. The terminals can be soldered to get an electrical connection but it can also be a connection by friction force to achieve a signal transmission to the antenna element. FIG. 6 illustrates how a smaller spacer creates a space (66) where other components can be mounted to more efficient use the board surface area. FIG. 7 illustrates how the antenna elements (71) and terminal (72), where an extra folding creates a surface (73) that is placed onto a connection pad on the printed circuit board and thereafter is soldered. FIG. 8 illustrates how a spring loaded connector (83) can be modelled to get a antenna (81) that by appropriate spring force get a electrical connection at the spot (84) having electrical connection to the radio transmitter and/or receiver. In many case gold plating of the terminals and pads is needed to avoid bad electrical connection by oxides.

The printed circuit board usually contains the radio transmitter and/or receiver but it isn't necessary. The antenna element can be mounted on a separate printed circuit board.

The antenna element does not have to be placed on a ground plane and can sometimes benefit to wholly or partly be placed outside of the ground plane. The FIG. 10 illustrates a printed circuit board having one part (101) not covered by a ground plane and another part (102) that is covered by a ground plane. The antenna can be placed at any of the positions (103, 104, 105). The antennas properties will change depending if it is placed above a ground plane or not and the antenna can need different embodiment depending of placement position.

FIG. 12 illustrates a flow chart over the different step of the antenna manufacturing process according to this invention. It is obvious for a person skilled in the art that the steps can be performed in different order and that steps can be jointed and other steps in production added. Some steps don't need to be performed in production but can be done at assembly of the final product. FIG. 12 is a benchmark of a possible working process only.

Common insulators are air, different substrates for printed circuit boards, plastics and ceramics. Common electrical conductive materials for antenna element and ground plane are copper, silver, different alloys including the mentioned substances.

The radio signal can, as person skilled in the art realise, be connected to the antenna element either by direct or indirect coupling. By direct means a galvanic connection and by indirect means a capacitive or inductive coupling or a combination of both.

The person skilled in the art realise that this invention can be used in antenna systems including more than one antenna, for example systems for improved antenna gain, achieve space or polarization diversity or systems based on MIMO technology, meaning both transmitter and receiver having more than one antenna.

The person skilled in the art realise that the antenna can be used in one or more frequency bands either simultaneously or at different times. The antenna can have different radiation patterns by exciting different modes. It is obvious that the antenna can operate at different frequencies and excite other higher order of modes or resonance frequencies on the same antenna. This invention is not restricted to a particular mode or resonance but includes all.

The person skilled in the art realise that parasitic elements, for example one or more layer of electric conductive material apart from the antenna element. The parasitic element can be shaped either to increase the antenna bandwidth or achieve a efficient antenna at a separate frequency range. Parasitic element can also be used for impedance matching.

1. An antenna comprising an electrical conductive material having a first and second side and one or more electrical insulators characterised in that at least one electrical insulator having adhesive on two or more sides where at least one side, or maximum one side less than the total sides having adhesive is attached to the antenna element.

2. An antenna according to claim 1, characterised in that the antenna element having one or more bended or folded parts.

3. An antenna according to claim 1, characterised in that the insulator cover an area apparent less than the area of the antenna element.

4. An antenna according to claim 1 characterised in that the insulator having the relative dielectric constant below 2.

5. An antenna according to claim 1, characterised in that a coaxial cable is electrically connected to the antenna element.

6. An antenna according to claim 1, characterised in that the antenna element is intended to be mounted on a printed circuit board.

7. An antenna according to claim 1, characterised in that the signal from radio transmitter and/or receiver is connected to the antenna element.

8. An antenna according to claim 2, characterised in that the insulator cover an area apparent less than the area of the antenna element.

9. An antenna according to claim 2, characterised in that the insulator having the relative dielectric constant below 2.

10. An antenna according to claim 2, characterised in that a coaxial cable is electrically connected to the antenna element.

11. An antenna according to claim 2, characterised in that the antenna element is intended to be mounted on a printed circuit board.

12. An antenna according to claim 2, characterised in that the signal from radio transmitter and/or receiver is connected to the antenna element.

13. An antenna according to claim 8, characterised in that the insulator having the relative dielectric constant below 2.

14. An antenna according to claim 8, characterised in that a coaxial cable is electrically connected to the antenna element.

15. An antenna according to claim 8, characterised in that the antenna element is intended to be mounted on a printed circuit board.

16. An antenna according to claim 8, characterised in that the signal from radio transmitter and/or receiver is connected to the antenna element.

17. An antenna according to claim 3, characterised in that the insulator having the relative dielectric constant below 2.

18. An antenna according to claim 3, characterised in that a coaxial cable is electrically connected to the antenna element.

19. An antenna according to claim 3, characterised in that the antenna element is intended to be mounted on a printed circuit board.

20. An antenna according to claim 3, characterised in that the signal from radio transmitter and/or receiver is connected to the antenna element.
